(19) United States
(12) Patent Application Publication
(10) Pub. No.: US 2007/0081485 A1
(43) Pub. Date: Apr. 12, 2007

(54) Method,station and computer programme for accessing radio resources in and ad-hoc radio communication system

(76) Inventor: Hui Li, Beijing (CN)

Correspondence Address: STAAS & HALSEY LLP, SUITE 700, 1201 NEW YORK AVENUE, N.W., WASHINGTON, DC, 20005, US

(21) Appl. No.: 10/577,671

(22) PCT Filed: Sep. 9, 2004
(86) PCT No.: PCT/EP04/52106

§ 371 Date: May 1, 2006

(30) Foreign Application Priority Data
Oct. 31, 2003 (DE) 103 50 907.0

(51) Int. Cl. H04Q 7/00

(52) U.S. Cl. 370/328

(57) ABSTRACT

A signaling method relates to an intended data transmission from a first radio station to a second radio station in an ad-hoc mode of a radio communications system. The communication between the radio stations takes place in the as-hoc mode with the aid of a frequency band that is divided into a plurality of sub-bands, whereby one or more first sub-bands is/are assigned to the first radio station and one or more second sub-bands is/are assigned to the second radio station for the communication process. The radio station transmits an announcement of the intended data transmission to the second radio station on one or more sub-bands corresponding to a first number of sub-bands, the sub-band or bands of said first number of sub-bands corresponding to a first number of sub-bands, the sub-band or bands of said first number of sub-bands consisting of one or more of the first sub-bands corresponding to a second number of sub-bands, the sub-band or bands of said second number of sub-bands consisting of one or more of the first sub-bands and/or one or more of the second sub-bands.

### CROSS REFERENCE TO RELATED APPLICATIONS

This application is based on and hereby claims priority to PCT Application No. PCT/EP2004/052106 filed on Sep. 9, 2004 and German Application No. 10350907.0 filed on Oct. 31, 2003, the contents of which are hereby incorporated by reference.

### BACKGROUND OF THE INVENTION

The invention relates to a method for signaling relating to an intended data transmission from a first radio station to a second radio station in an ad-hoc mode of a radio communication system.

Furthermore, the invention relates to a radio station for communicating with another radio station in an ad-hoc mode of a radio communication system and a computer program product for a radio station in an ad-hoc mode of a radio communication system.

In radio communication systems, information (e.g. signaling or user data such as voice, images, short messages or other data) is transmitted by electromagnetic waves via a radio interface between sending radio station and receiving radio station.

Radio communication systems are often designed as cellular systems, e.g. according to the GSM (Global System for Mobile Communication) or UMTS (Universal Mobile Telecommunications System) standard, having a network infrastructure comprising e.g. base stations, entities for monitoring and controlling the base stations and further entities on the network side. Frequencies at 900, 1800 and 1900 are used for the cellular GSM mobile radio system. At present, the cellular systems mainly transfer voice, fax and short messages SMS (Short Message Service).

In addition to these cellular hierarchical radio networks, which are organized on a wide-area (supralocal) basis, provision is also made for wireless local networks (WLANs, Wireless Local Area Networks) which usually have a radio coverage area that is considerably more limited in spatial terms. The cells which are covered by the radio access points (AP: Access Point) of the WLANs are small in comparison with normal mobile radio cells, having a diameter of up to several hundred meters. Examples of various standards for WLANs include HiperLAN, DECT, IEEE 802.11, Bluetooth and WATM. At present, however, it appears that almost exclusively those products based on the IEEE 802.11 family are becoming generally accepted as local radio-controlled networks, particularly in the USA and Europe.

The unlicensed frequency range around 2.4 GHz is generally used for WLANs, wherein the data transmission speeds allow up to 11 Mbit/s. Future WLANs will be able to operate in the 5 GHz range and achieve data speeds of more than 50 Mbit/s. WLAN subscribers therefore benefit from data speeds which are considerably higher than those offered by the third generation of mobile radio. Access to WLANs for connections requiring high bit rates is therefore advantageous for the transmission of large data volumes, particularly in connection with Internet accesses.

Whereas the communication between subscriber-based radio stations of a cellular mobile radio communication system generally takes place via base stations, subscriber-based radio stations in an ad-hoc mode of a radio communication system can establish a radio connection between themselves without a central switching entity. In this case, the connection between these radio stations takes place either directly or, in the case of greater distances, via other radio stations which form relay stations for this connection. The radio stations of a self-organizing network can be mobile radio stations (e.g. mobile radio devices belonging to individuals or in commercial vehicles) and/or predominantly stationary radio stations (e.g. computers, printers, household devices). In order to be part of an ad-hoc network, a radio station must be located within the radio coverage area of at least one adjacent radio station. Examples of self-organizing networks include the WLANs.

The access of radio stations to the shared radio resources of the transmission medium, e.g. time, frequency, throughput or space, is governed by multiple access methods (MA) in the case of radio communication systems. In the case of orthogonal frequency division multiplexing (OFDM), a frequency band is divided into equidistant orthogonal sub-bands or sub-carriers. As a rule, the subscriber-based radio station is then assigned all or part of the sub-bands for communication.

### SUMMARY OF THE INVENTION

The method addresses the problem of setting forth a method of the type cited at the beginning, which allows efficient execution of the signaling between a sending radio station and a receiving radio station in advance of the transmission of data in an ad-hoc mode of a radio communication system. It furthermore sets forth a subscriber-based radio station and a computer program product, which is suitable for a radio station in an ad-hoc mode, for carrying out the method.

In the method, an intended data transmission from a first radio station to a second radio station is signaled in an ad-hoc mode of a radio communication system. The communication of radio stations in the ad-hoc mode takes place using a frequency band which is divided into a plurality of sub-bands, wherein the first radio station is assigned one or more first sub-bands and the second radio station is assigned one or more second sub-bands for communicating. Furthermore, the first radio station sends a notification of the intended data transmission to the second radio station on one or more sub-bands corresponding to a first number of sub-bands. In this context, the sub-band or the sub-bands of the first number of sub-bands consist of one or more of the first sub-bands and/or one or more of the second sub-bands.

In an ad-hoc mode of a radio communication system, subscriber-based radio stations such as mobile computers or mobile telephones, for example, communicate without the need for intermediate switching by a network-based entity. According to the invention, sub-bands of a frequency band are assigned to the radio stations for communicating, wherein this assignment can take place e.g. by a base station or a radio access point of a WLAN. The method is particularly applicable in the event that the first sub-band or bands, these being assigned to the first radio station, differ from the second sub-band or bands assigned to the second radio station. As a result of the notification from the first radio station of the intended data transmission, the second radio station is informed that the first radio station plans to send data to said second radio station. The notification can include information about the type and the quantity of the data which is to be sent, about the duration of the data transfer, the sender and the addressees of the data, and about sub-bands on which the first radio station plans to transmit the data. The notification can have the effect that those radio stations within the radio coverage area of the first radio station which receive the notification consider those sub-bands of the first number of sub-bands which are used for the notification as reserved for a data transmission of the first radio station, and therefore do not access said sub-bands during the period which is relevant for the data transmission.

In a development, the first radio station detects a current occupancy of first and/or second sub-bands prior to sending the notification, and the sub-band or the sub-bands of the first number of sub-bands consist of one or more sub-bands which are currently detected as not occupied. On the basis of the detection, the first radio station can register whether first and/or second sub-bands in the area of its radio coverage are currently reserved or being used for communication by other radio stations. The detection can relate to the totality of the first and second sub-bands and to subsets thereof. Sending the notification exclusively on sub-bands which have been detected as not currently occupied has the advantage that, as a consequence, the first radio station does not generate any interference signals which interfere with signals that are sent by other radio stations within the radio range of the first radio station.

In the event that the data must be sent to the second radio station as sole addressee, the sub-band or sub-bands of the first number of sub-bands can consist of a set of the unoccupied first sub-band or sub-bands, assuming at least one first sub-band is detected as currently unoccupied. This means that, if at least one of the sub-bands assigned to the first radio station is currently available, for sending the notification the first radio station only uses a free sub-band or a plurality of free sub-bands which it has been assigned. This assists a realistic estimation of the utilization of the sub-bands by those radio stations to which the sub-bands were assigned.

In the event that the data must be sent to the second radio station as sole addressee, the sub-band or sub-bands of the first number of sub-bands can consist of a set of the unoccupied second sub-band or sub-bands, assuming the first sub-bands are detected as currently occupied and at least one second sub-band is detected as currently unoccupied. Therefore, in the event that all of the sub-bands which have been assigned to the first radio station are occupied, the method provides for switching over to one or more currently unoccupied sub-bands of the second radio station.

If the data must be sent to a third radio station as an addressee in addition to the second radio station, said third radio station having been assigned one or more third sub-bands for communicating, the sub-band or sub-bands of the first number of sub-bands can consist of a set of the unoccupied first sub-band or sub-bands and a set of the unoccupied second sub-band or sub-bands, assuming at least one first sub-band is detected as currently unoccupied and at least one second sub-band is detected as currently unoccupied. In the described case, the data must be successfully received not only by the second radio station, but also by one or even by a plurality of third radio stations. Third sub-bands are assigned to the third radio station for communicating, wherein the third sub-bands usually differ from the first sub-bands and the second sub-bands. If the first radio station finds that at least a subset of the first sub-bands and at least a subset of the second sub-bands are currently available for communicating, it sends the notification on at least one of the first sub-bands and at least one of the second sub-bands.

However, if the data must be sent to a third radio station as an addressee in addition to the second radio station, and the first sub-bands are detected as occupied and at least one second sub-band is detected as currently unoccupied, the sub-band or sub-bands of the first number of sub-bands can consist of a set of the unoccupied second sub-band or sub-bands.

The second radio station receives a notification from the first radio station, on one or more sub-bands corresponding to a first number of sub-bands, of the intended data transmission from the first radio station to the second radio station. Following the receipt of the notification, the second radio station sends an acknowledgement to the first radio station, on one or more sub-bands corresponding to a second number of sub-bands, of the intended data transmission. In this context, the sub-band or sub-bands of the second number of sub-bands consist of one or more of the first sub-bands and/or one or more of the second sub-bands.

The acknowledgement of the intended data transmission by the second radio station indicates to the first radio station that the second radio station is ready to receive the data. On other radio stations, the acknowledgement of the second radio station has the effect that the sub-bands of the second number of sub-bands are considered as reserved. Consequently, the other radio stations within the radio range of the second radio station do not transmit any data on the sub-band or sub-bands of the second number of sub-bands. This applies during a time window which the other radio stations can extract from the content of the acknowledgement.

In a development, prior to sending the acknowledgement, the second radio station detects a current occupancy of first and/or second sub-bands, and the sub-band or sub-bands of the second number of sub-bands consist of one or more sub-bands which have been detected as currently unoccupied. The detection by the second radio station can relate either to a subset or to all sub-bands of the first sub-bands and/or the second sub-bands.

The detection by the second radio station can also be limited to the sub-band or sub-bands of the first number of sub-bands. After the detection, the acknowledgement is only sent on sub-bands which are not currently used or reserved in the radio coverage area of the second radio station. A reservation could occur e.g. due to the sending of a notification and/or acknowledgement by other radio stations on the relevant sub-bands.

If the second radio station detects that the sub-band or sub-bands of the first number of sub-bands are unoccupied, the sub-band or sub-bands of the second number of sub-bands can correspond to the sub-band or sub-bands of the first number of sub-bands. In this case, the second radio station sends the acknowledgement on all sub-bands which the first radio station used for sending the notification. This corresponds to the reservation of a maximal possible number of sub-bands by the second radio station, with reference to the sub-bands which were reserved by the first radio station as a result of the notification.

It is advantageous for the sub-band or sub-bands of the second number of sub-bands to correspond to a subset of the sub-bands of the first number of sub-bands, if the second radio station detects that the sub-band or sub-bands of the subset are unoccupied and that the remaining sub-band or sub-bands of the first number of sub-bands are occupied. If the second radio station finds that some of the sub-bands used for the notification are free but others are currently occupied, therefore, the sending of the acknowledgement takes place on the sub-bands which are found to be free.

In a development, after receiving the acknowledgement, the first radio station sends the data to the second radio station on one or more sub-bands corresponding to a third number of sub-bands, wherein the sub-band or sub-bands of the third number of sub-bands consist of one or more of the first sub-bands and/or one or more of the second sub-bands. If the sending of an acknowledgement by the second radio station does not take place, e.g. in the event that the second radio station detects that all first and all second sub-bands are occupied, it is advantageous that the sending of the data by the first radio station likewise does not take place.

In a configuration of the method, the sub-band or sub-bands of the third number of sub-bands correspond to
the sub-band or sub-bands of the first number of sub-bands or
a subset of the sub-bands of the first number of sub-bands or
the sub-band or sub-bands of the second number of sub-bands or
a subset of the sub-bands of the second number of sub-bands.

The choice of which sub-bands are used for sending the data therefore depends on the choice of the sub-bands used for the notification and/or for the acknowledgement.

The radio station has a memory to store information via one or more first sub-bands which are assigned to the radio station for communicating, said sub-bands belonging to a frequency band which is divided into a plurality of sub-bands, and a memory to store information via one or more second sub-bands which are assigned to the other radio station for communicating, said sub-bands belonging to the frequency band. In this context, the stored information is configured in such a way that the radio station, using the information, is able to carry out a communication with the other radio station both on the first and on the second sub-bands. Furthermore, the radio station has a transmitter to send the other radio station a notification of an intended data transmission to the other radio station on one or more sub-bands corresponding to a first number of sub-bands. The sub-band or sub-bands of the first number of sub-bands consist of one or more of the first sub-bands and/or one or more of the second sub-bands.

In a configuration, the radio station also includes a mechanism for detecting a current occupancy of first and/or second sub-bands prior to sending the notification, and a mechanism for selecting the sub-band or sub-bands of the first number of sub-bands depending on a detection result of the occupancy of first and/or second sub-bands.

The radio station is particularly suitable for carrying out the method.

The radio station has a memory to store information via one or more first sub-bands which are assigned to the radio station for communicating, said sub-bands belonging to a frequency band which is divided into a plurality of sub-bands, and a memory to store information via one or more second sub-bands which are assigned to the other radio station for communicating, said sub-bands belonging to the frequency band. Furthermore, the radio station has a mechanism for receiving and analyzing a notification from the other radio station of an intended data transmission from the other radio station to the radio station on one or more sub-bands corresponding to a first number of sub-bands. Following receipt of the notification, the radio station lastly has a transmitter to send an acknowledgement to the other radio station, on one or more sub-bands corresponding to a second number of sub-bands, of the intended data transmission, wherein the sub-band or sub-bands of the second number of sub-bands consist of one or more of the first sub-bands and/or one or more of the second sub-bands.

In a configuration, the radio station also includes a mechanism for detecting a current occupancy of first and/or second sub-bands prior to sending the notification, and a mechanism for selecting the sub-band or sub-bands of the second number of sub-bands depending on a detection result of the occupancy of first and/or second sub-bands, and depending on the sub-band or sub-bands of the first number of sub-bands. Consequently, the radio station can select the sub-bands to be used for sending the acknowledgement independently of which sub-bands the other radio station has used for sending the notification.

The radio station is particularly suitable for carrying out the method. In particular, a radio station can include both the parts of the first described radio station, and the parts of the second described radio station.

The computer program product is used for selecting one or more sub-bands which will be used for sending, to another radio station, a notification of an intended data transmission from the radio station to the other radio station, said selection being made from one or more first sub-bands which have been assigned to the radio station for communicating and/or from one or more second sub-bands which have been assigned to the other radio station for communicating, said sub-bands belonging to a frequency band which is divided into a plurality of sub-bands.

The computer program product according to the invention is used for selecting one or more sub-bands which will be used for sending, to another radio station, an acknowledgement of an intended data transmission from the other radio station to the radio station, said selection being made from one or more first sub-bands which have been assigned to the radio station for communicating and/or from one or more second sub-bands which have been assigned to the other radio station for communicating, said sub-bands belonging to a frequency band which is divided into a plurality of sub-bands.

The computer program products are particularly suitable for carrying out the method, and can include further suitable functionality for this purpose.

In connection with the proposed method, in addition to the actual computer program (including its technical effects which go beyond the normal physical interworking between program and computing unit), a computer program product is understood to mean in particular a recording medium for the computer program, a collection of files, a configured computing unit, and also a storage device or a server, for example, on which the files associated with the computer program are stored.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a radio communication system,

FIG. 2 shows the related art relating to an access to radio resources as per IEEE 802.11,

FIG. 3a schematically shows a first implementation of the method for sending of signals on sub-bands,

FIG. 3b schematically shows a second implementation of the method for sending of signals on sub-bands,

FIG. 3c schematically shows a third implementation of the method for sending of signals on sub-bands,

FIG. 3d schematically shows a fourth implementation of the method for sending of signals on sub-bands,

FIG. 4 shows a first radio station in accordance with one embodiment of the invention,

FIG. 5 shows a second radio station in accordance with one embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

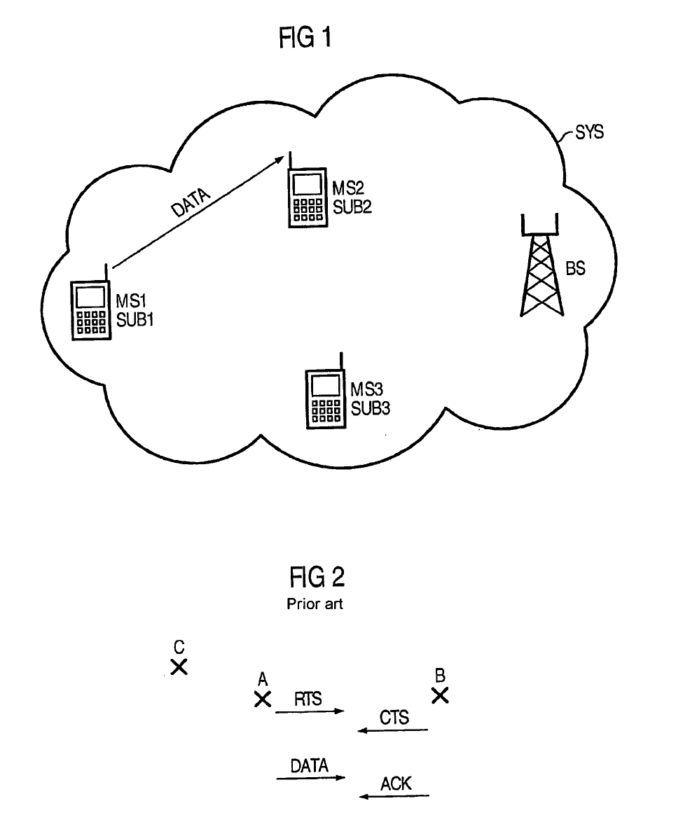

FIG. 1 shows a radio communication system SYS which includes three mobile stations MS1, MS2 and MS3 and a base station BS. The radio communication system can have further mobile stations, which are not illustrated in FIG. 1 for the sake of clarity. An interface from the base station to a core network is likewise not illustrated in FIG. 1. Within the radio communication system SYS under consideration, there exists an ad-hoc mode in which the mobile stations MS1, MS2 and MS3 can communicate directly with each other without the need for data to be routed through the base station BS.

In order to communicate in the ad-hoc mode, the mobile stations MS1, MS2 and MS3 use an OFDM transmission method. In this context, a frequency band is divided into a multiplicity of sub-bands, wherein sub-bands are assigned to the mobile stations MS1, MS2 and MS3 for communicating. This assignment of sub-bands to the mobile stations MS1, MS2 and MS3 is done by the base station BS. For this, the base station BS is connected to an entity for managing radio resources. When assigning the sub-bands, one or more sub-bands can be assigned to a mobile station. It is also possible for a sub-band to be assigned to a plurality of mobile stations. The assignment of sub-bands to the mobile stations takes place dynamically, and therefore a. change of the sub-bands assigned to a mobile station can occur depending on the requirements of the individual mobile stations, for example. In FIG. 1, the sub-band SUB1 is currently assigned to the mobile station MS1, the sub-band SUB2 to the mobile station MS2, and the sub-band SUB3 to the mobile station MS3. Whereas the sub-bands SUB1, SUB2 and SUB3 differ from each other, it is possible for another mobile station to be located in the vicinity of the mobile station MS1, for example, and be assigned the same sub-band SUB1.

The base station BS also informs the mobile stations MS1, MS2 and MS3 of the sub-bands which have been assigned to their neighboring mobile stations. Neighboring mobile stations are understood to include those mobile stations which are located within the relevant radio coverage area of the other mobile station, such that they can communicate via a single hop without routing of the data by other mobile stations. Therefore the mobile station MS1 knows that the mobile station MS2 has been assigned the sub-band SUB2 and the mobile station MS3 has been assigned the sub-band SUB3. If data is sent from a sending mobile station to a remote receiving mobile station which is not a neighboring mobile station, the sending mobile station sends the data to a neighboring mobile station, which in turn forwards the data to one of its neighboring mobile stations, etc., until the data reaches the receiving mobile station. For this, the mobile stations utilize the knowledge of the sub-bands which have been assigned to their neighboring mobile stations.

Whereas the radio resource of the frequency or the sub-bands is therefore distributed centrally by the base station BS among the mobile stations MS1, MS2 and MS3 of the radio communication system SYS, such a central distribution of the radio resource does not currently exist in the ad-hoc mode. In this context, the access to the radio resource is currently managed by the mobile stations MS1, MS2 and MS3 in a self-organizing manner instead.

In self-organizing networks according to the IEEE 802.11 standard, said networks being based on the TDD (time division duplex) principle, the utilization of the radio resource of time for the data transmission between two mobile stations, or the signaling relating to this data transmission, takes place without the support of a central unit, as is also the case in the radio communication system SYS in FIG. 1. The MAC protocol (MAC: Medium Access Control) which is used for this purpose is based on the multiple access method CSMA/CA (Carrier Sense Multiple Access with Collision Avoidance), and this is briefly explained below with reference to FIG. 2.

If a data transmission is to take place between a mobile station A (sending mobile station) and a mobile station B (receiving mobile station), the mobile station A first listens to the transmission frequency. If the transmission medium is free for a specified duration (Distributed Inter Frame Space, DIFS), i.e. if the frequency is not currently being used for another transmission, the mobile station A sends a Request to Send control frame RTS containing information about the volume of data to be transmitted. If the mobile station B replies with a Clear to Send control frame CTS, the mobile station A then transmits the data DATA. Following the error-free receipt of the data DATA, the mobile station B sends an acknowledgement ACK of the correct receipt. If the mobile station A does not receive the control frame CTS within a specific period, however, it tries to effect a transmission again after a random delay time by emitting the control frame RTS again.

In order to prevent collisions during transmissions, other mobile stations, e.g. the mobile station C, which receive both the control frame RTS of the mobile station A and the control frame CTS of the mobile station B, are not allowed to use the transmission medium until they have received the acknowledgement ACK from the mobile station B. If the mobile station C only receives the control frame RTS from the mobile station A, it must not use the transmission medium for the duration of the time window which is required for transmitting the data volume, as specified in the RTS control frame, from the mobile station A to the mobile station B. If the mobile station C only receives the CTS control frame from the mobile station B, it must wait until it also receives the acknowledgement ACK which is sent by the mobile station B. This prevents access to the radio resources by those mobile stations which are located within the range of the mobile station A and/or the mobile station B and could interfere with the transmission between the mobile stations A and B by utilizing the same resource.

Whereas in the case of a conventional IEEE 802.11 radio communication system, the mobile stations have access to a frequency for data transmission and for sending the control frames RTS, CTS and the acknowledgement ACK, in the radio communication system SYS according to FIG. 1 each mobile station is assigned sub-bands for communicating, wherein said sub-bands normally differ from each other. Consequently, the method described in FIG. 2 for a TDD system cannot be transferred to the OFDM system.

Consideration is given below to the case in which the mobile station MS1 intends to send data DATA to the mobile station MS2. In addition to this, it knows that the sub-band SUB2 is assigned to the mobile station MS2. Conversely, the mobile station MS2 knows that the sub-band SUB1 is assigned to the mobile station MS1. The mobile stations MS1 and MS2 can therefore communicate on the sub-band SUB1 or on the sub-band SUB2 or on both sub-bands SUB1 and SUB2.

When selecting the sub-bands on which the forthcoming data transmission from the mobile station MS1 to the mobile station MS2 will be signaled, it must be remembered that sub-bands which are currently being used by other mobile stations should not be utilized for the data transmission, so that the communication that is currently taking place on the relevant sub-band is not disrupted. Furthermore, it must be ensured that the sub-band on which the data is transmitted from the mobile station MS1 to the mobile station MS2 is not being used concurrently by neighboring mobile stations of the mobile station MS2, in order to avoid any disruption of the data transmission between the mobile stations MS1 and MS2.

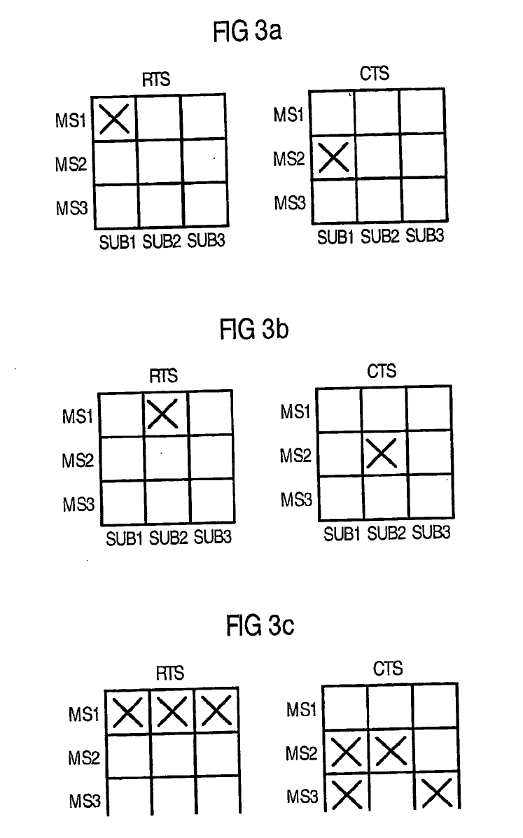

The mobile station MS1 monitors its sub-band SUB1 and the sub-bands SUB2 and SUB3 of its neighboring mobile stations MS2 and MS3. It can therefore detect whether these sub-bands are currently being used for communication by other mobile stations within their radio coverage area. FIG. 3a illustrates the case in which the mobile station MS1 has ascertained that the sub-band SUB1 is unoccupied. In FIGS. 3a, 3b, 3c and 3d, the sending of control signals RTS or CTS by the mobile stations MS1, MS2 and MS3 on the relevant sub-bands SUB1, SUB2 and SUB3 is characterized by crosses in the grids, wherein the sub-bands SUB1, SUB2 and SUB3 are drawn towards the right and the mobile stations MS1, MS2 and MS3 are drawn towards the top within the grid.

In the left-hand part of FIG. 3a, the mobile station MS1 sends a control signal RTS to the mobile station MS2 on the sub-band SUB1, as a result of which the forthcoming data transmission is notified. The quantity and the addressees of the data can be derived from the control signal RTS. The control signal RTS therefore includes the duration of the forthcoming data transmission, as well as the identification information of the sender and recipient.

The mobile station MS2 also monitors its sub-band SUB2 and the sub-bands of its neighboring mobile station. After it has received the control signal RTS, it establishes that the sub-band SUB1 is also unoccupied within its radio coverage area. It sends a control signal CTS, from which can be ascertained that it is ready to receive the data, back to the mobile station MS1 on the sub-band SUB1 as shown in the right-hand part of FIG. 3a. Like the control signal RTS, the control signal CTS also contains information about the duration of the forthcoming data transmission.

Due to the sending of control signals RTS and CTS on the sub-band SUB1, the mobile stations within the radio coverage area of the mobile stations MS1 and MS2 are prohibited from sending information on the sub-band SUB1 during the period which can be derived from the control signals RTS and CTS.

Following the receipt of the control signal CTS by the mobile station MS1, the latter sends the data DATA to the mobile station MS2 on the reserved sub-band SUB1, whereupon the receipt acknowledgement of the mobile station MS2 is sent on the sub-band SUB1.

If a plurality of sub-bands has been assigned to the mobile station MS1, the described sending of the control signals RTS and CTS can take place on all or on a subset of the sub-bands. For this, the mobile station MS1 checks which of the sub-bands it has been assigned are currently unoccupied. The control signal RTS should be sent on those unoccupied sub-bands which are to be used subsequently for sending the data. Following the receipt of the control signal RTS, the mobile station MS2 checks which of the sub-bands that were used for the control signal RTS are unoccupied. The sending of the control signal CTS advantageously takes place on all free sub-bands on which the control signal RTS was sent. If some of these sub-bands are occupied, those remaining unoccupied sub-bands on which the control signal RTS was sent are used for transmitting the control signal RTS. Next, the mobile station MS1 transmits the data on those sub-bands on which the control signal CTS was sent. However, it is also possible for only a subset of these sub-bands to be used for sending the data. Likewise, it is possible for all sub-bands of the control signal CTS or only a subset of these sub-bands to be used for subsequently sending the receipt acknowledgement.

In FIG. 3b, consideration is given to the case in which the mobile station MS1 has established that the sub-band SUB1 is currently occupied but that the sub-band SUB2 is currently unoccupied. The mobile station MS1 therefore sends the control signal RTS on the sub-band SUB2 in the left-hand part of FIG. 3b, whereupon the mobile station MS2 replies with a control signal CTS on the sub-band SUB2 in the right-hand part of FIG. 3b. The data transmission and the acknowledgement of the correct receipt of the data likewise take place on the sub-band SUB2. If the mobile station MS2 has been assigned a plurality of sub-bands, the above explanations relating to the plurality of sub-bands assigned to the mobile station MS1 apply analogously.

In general, the sending of a control signal RTS by the mobile station MS1 can therefore take place on one or more of the sub-bands assigned to said mobile station MS1, on one or more of the sub-bands assigned to the mobile station MS2, or on any combination of these sub-bands. The inventor proposes, however, that the mobile station MS1 takes into consideration which of the sub-bands, from this overall set of sub-bands which have been assigned to the mobile stations MS1 and MS2 for communication, are currently unoccupied. For sending the control signal RTS and for subsequently sending the data, however, the mobile station MS1 should preferably use the sub-bands it has been assigned. This makes it easier for the entity having responsibility for the assignment of sub-bands to estimate the utilization of the relevant sub-bands by the mobile stations to which these sub-bands were assigned.

As in the case of the control signal RTS, the sending of the control signal CTS can likewise take place on one or more of the sub-bands assigned to said mobile station MS1, on one or more of the sub-bands assigned to the mobile station MS2, or on any combination of these sub-bands. However, the mobile station MS2 should not use any sub-band which was not used for the control signal RTS. Furthermore, the mobile station MS2 performs a check on the sub-bands which were used by the mobile station MS1 for the control signal RTS, in order to ascertain their current occupancy in the radio coverage area of the mobile station MS2. This reveals the sub-bands for the control signal CTS as those sub-bands of the control signal RTS which are not currently occupied.

As in the case of the control signals RTS and CTS, the sending of the data from the mobile station MS1 to the mobile station MS2 can likewise take place on one or more of the sub-bands assigned to the mobile station MS1, on one or more of the sub-bands assigned to the mobile station MS2, or on any combination of these sub-bands. In order to ensure that the data transmission is not disrupted by other transmissions on the same sub-bands, however, whenever possible the data is preferably transmitted on those sub-bands on which both the control signal RTS and the control signal CTS were sent. The use of a subset of the sub-bands on which both the control signal RTS and the control signal CTS were sent is possible. Use of sub-bands on which neither the control signal CTS nor the control signal RTS was sent does not therefore occur.

The corresponding explanation relating to the sending of the data applies equally to the selection of the sub-bands for sending the acknowledgement of the correct receipt of the data by the mobile station MS2.

In FIGS. 3c and 3d, consideration is given to the case in which the data that the mobile station MS1 intends to send is addressed to both the mobile station MS2 and the mobile station MS3.

In FIG. 3c, the mobile station MS1 has established that the three sub-bands SUB1, SUB2 and SUB3 are currently unoccupied. The control signal RTS is then sent on the sub-bands SUB1, SUB2 and SUB3 in the left-hand part of FIG. 3c. The mobile stations MS2 and MS3 have likewise established that the sub-bands SUB1, SUB2 and SUB3 are unoccupied in their radio coverage areas. Consequently, the mobile station MS2 sends the control signal CTS on the sub-bands SUB1 and SUB2, while the mobile station MS3 sends the control signal CTS on the sub-bands SUB1 and SUB3 in the right-hand part of FIG. 3c. The fact that the control signal CTS is transmitted not only on the sub-band SUB1 but also on the sub-bands SUB2 and SUB3 has the advantage that the mobile station MS1 is able to differentiate between the two control signals CTS which are sent on different sub-bands SUB2 and SUB3.

The subsequent sending of the data can take place on all three sub-bands SUB1, SUB2 and SUB3. However, it is advantageous for the data to be sent solely on the sub-band SUB1. If e.g. the sub-band SUB2 were used for sending, the mobile station MS3 could be prevented from correctly receiving the data by interference signals on the sub-band SUB2 within its radio coverage area, because the sub-band SUB2 was not reserved by a control signal CTS within this radio coverage area. In order to avoid this problem, the data for the mobile station MS3 can be sent on the sub-band SUB3 in addition to or as an alternative to the sub-band SUB1. For the mobile station MS2, the data is sent on the sub-band SUB2 in addition to or as an alternative to sending on the sub-band SUB1. A combined data transfer to both the mobile stations MS2 and MS3 can therefore take place on the sub-band SUB1, while the data is sent separately to the mobile stations MS2 and MS3 on the sub-bands SUB2 and SUB3.

The acknowledgements from the mobile stations MS2 and MS3 take place after the receipt of the data on the sub-band SUB2 for the mobile station MS2 and on the sub-band SUB3 for the mobile station MS3, such that the mobile station MS1 is able to distinguish between the acknowledgements.

FIG. 3d shows the case in which the mobile station MS1 has established that the sub-band SUB1 which was assigned to it is currently occupied. In this case, it sends the control signal RTS to the two mobile stations MS2 and MS3 on the sub-bands SUB2 and SUB3 in the left-hand part of FIG. 3d. After the mobile stations MS2 and MS3 have checked that the relevant sub-band SUB2 and SUB3 is also available in their neighborhood, the control signal CTS is sent by the mobile station MS2 on the sub-band SUB2 and by the mobile station MS3 on the sub-band SUB3 as shown in the central part of FIG. 3d.

The data transmission can then take place on one of the two sub-bands SUB2 or SUB3 or even on both sub-bands SUB2 and SUB3. In this context, however, the previously described problem arises that the error-free receipt for the mobile stations MS2 and MS3 can be disrupted if the band which was assigned respectively to the other mobile station is currently being used in the local neighborhood. It is therefore possible, as described above, to transmit the data for the mobile station MS2 on the sub-band SUB2 and the data for the mobile station MS3 on the sub-band SUB3.

In the context of a further possibility for avoiding this problem, the mobile station MS1 can prompt the mobile stations MS2 and MS3, in the control signal RTS, to also send a control signal CTS on the sub-band which is assigned to the other mobile station MS2 or MS3 respectively. In this case, both mobile stations MS2 and MS3 send a control signal CTS on the sub-bands SUB2 and SUB3 as illustrated in the right-hand part of FIG. 3d. However, the solution in the right-hand part of the FIG. 3d has the disadvantage that the mobile station MS1 cannot distinguish between the control signals CTS of the two mobile stations MS2 and MS3 because they are sent on identical sub-bands.

The sending of an acknowledgement of the receipt of data by the mobile stations MS2 and MS3 can take place, in both the central and the right-hand part of the FIG. 3d, on the sub-band SUB2 for the mobile station MS2 and on the sub-band SUB3 for the mobile station MS3.

If a mobile station intends to send data to a plurality of recipients, it should send a control signal RTS at least on the sub-bands which are assigned to the plurality of recipients. This has the effect of reserving these sub-bands within the neighborhood of the mobile station, such that the control signal CTS and the receipt acknowledgements from the recipients are transmitted without interference on these sub-bands and can be separated by the mobile station. If the sub-band assigned to the mobile station is also available, the control signal RTS should be sent on this sub-band. This sub-band can then be used subsequently for the data transmission.

The above explanations can also be applied to the case in which a plurality of sub-bands are assigned to the mobile stations. In this regard, instead of one sub-band per mobile station being used for sending the control signals RTS and CTS and the data as previously considered, one or more of the sub-bands assigned to a mobile station are used in each case. The data should preferably be transmitted on those sub-bands which were used to send both a control signal RTS and a control signal CTS from all recipients. Furthermore, the control signals CTS from the recipients should be sent on different sub-bands whenever possible, such that differentiation is possible. The sub-bands used for the control signals RTS and CTS can be selected accordingly. With regard to the control signal CTS, it is possible for the mobile station sending the control signal RTS to give instructions concerning the sub-bands on which a control signal CTS must be sent, provided these sub-bands are available in the radio coverage area of the mobile station sending the control signal CTS.

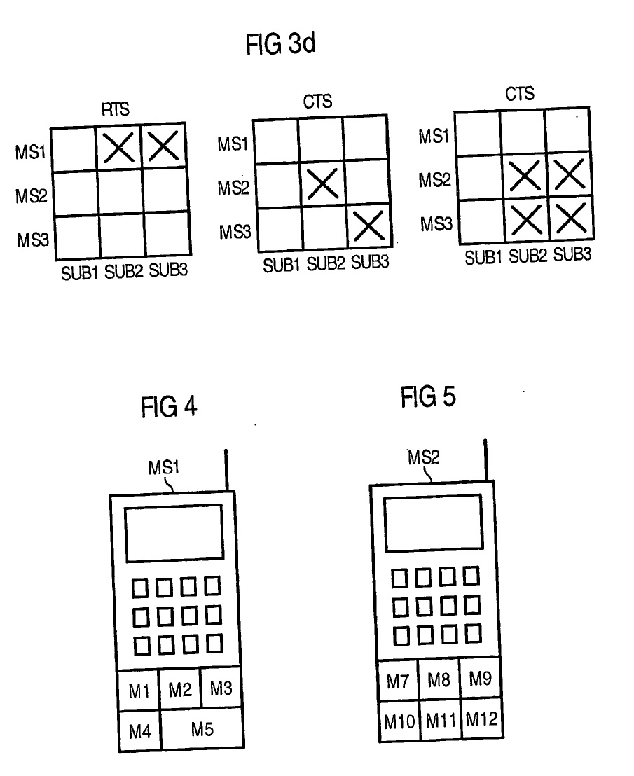

FIG. 4 shows the mobile station MS1 with a memory M1 for storing information about the sub-bands which have been assigned to it and a memory M2 for storing information about the sub-bands which have been assigned to its neighboring mobile stations. The transmitters M3 allows it to send a control signal RTS to a receiving mobile station in order to give notification of a forthcoming data transmission, wherein this sending takes place on one or more of the sub-bands which have been assigned to it and/or on one or more of the sub-bands which have been assigned to the receiving mobile station. The mechanism M4 is used for monitoring its sub-bands and/or the sub-bands of its neighboring mobile stations in order to determine whether they are occupied in its radio coverage area. The mechanism M5 enables the mobile station MS1 to select sub-bands for sending the control signal RTS depending on whether the sub-bands are currently occupied.

FIG. 5 illustrates the mobile station MS2 with a memory M7 for storing information about the sub-bands which have been assigned to it and a memory M8 for storing information about the sub-bands which have been assigned to its neighboring mobile stations. The receiver M9 allows it to receive a control signal RTS from another mobile station as notification of a forthcoming data transmission. The transmitter M10 is used for sending a control signal CTS, wherein this sending takes place on one or more of the sub-bands which have been assigned to it and/or on one or more of the sub-bands which have been assigned to the other mobile station. The mechanism M11 is used for monitoring its sub-bands and/or the sub-bands of its neighboring mobile stations in order to determine whether they are occupied in its radio coverage area. The mechanism M12 enables the mobile station MS2 to select sub-bands for sending the control signal CTS depending on whether the sub-bands are currently occupied and depending on which sub-bands were used for the control signal RTS.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-18. (canceled)

19. A method for signaling relating to an intended data transmission from a first radio station to a second radio station in an ad-hoc mode of a radio communication system, comprising:
dividing a frequency band into a plurality of sub-bands for communicating between the radio stations in the ad-hoc mode, wherein the first radio station is assigned one or more first sub-bands and the second radio station is assigned one or more second sub-bands; and
sending a notification from the first radio station relating to the intended data transmission to the second radio station, the notification being sent only on one or more sub-bands selected from the group consisting of the one or more first sub-bands and the one or more second sub-bands.

20. The method as claimed in claim 19, wherein
the first radio station detects a current occupancy of the first and/or second sub-bands prior to sending the notification, and
the notification is sent only on one or more unoccupied sub-bands.

21. The method as claimed in claim 20, wherein
if the first sub-band is unoccupied and the data transmission is intended only for the second radio station, then the notification is transmitted only on the first sub-band.

22. The method as claimed in claim 20, wherein
if the data transmission is intended only for the second radio station, the second sub-band is unoccupied and the first sub-band is occupied, then the notification is sent only on the second sub-band.

23. The method as claimed in one of the claims 20, wherein
the data transmission is intended for a third radio station in addition to the second radio station,
said third radio station is assigned a third sub-band for communicating,
neither the first sub-band, nor the second sub-band is occupied, and
the notification is sent on both the first and second sub-bands.

24. The method as claimed in one of the claims 20, wherein
the data transmission is intended for a third radio station in addition to the second radio station,
said third radio station is assigned a third sub-band for communicating,
the first sub-band is occupied and the second sub-band is unoccupied, and
the notification is sent only on the second sub-band.

25. A method for signaling relating to an intended data transmission from a first radio station to a second radio station in an ad-hoc mode of a radio communication system, comprising:
dividing a frequency band into a plurality of sub-bands for communication between the radio stations in the ad-hoc mode, wherein the first radio station is assigned one or more first sub-bands and the second radio station is assigned one or more second sub-bands;
receiving a notification at the second radio station from the first radio station relating to the intended data transmission from the first radio station to the second radio station; and
after receiving the notification, sending an acknowledgement from the second radio station to the first radio station to acknowledge the intended data transmission, the acknowledgement being sent only on one or more sub-bands selected from the group consisting of one or more first sub-bands and one or more second sub-bands.

26. The method as claimed in claim 25, wherein
prior to sending the acknowledgement, the second radio station detects a current occupancy of the first and/or second sub-bands, and
the acknowledgement is sent only on one or more unoccupied sub-bands.

27. The method as claimed in claim 26, wherein
the second radio station detects a current occupancy for the one or more sub-bands used to send the notification, and
if the one or more sub-bands used to send the notification are unoccupied, then the acknowledgement is sent on the same one or more sub-bands used to send the notification.

28. The method as claimed in claim 26, wherein
the second radio station detects a current occupancy for the one or more sub-bands used to send the notification,
the second radio station detects that at least one of the sub-bands used to send the notification is occupied and a reminder of the sub-bands used to send the notification is unoccupied, and
the acknowledgement is sent on one or more sub-bands of the reminder.

29. A method for signaling relating to an intended data transmission from a first radio station to a second radio station in an ad-hoc mode of a radio communication system, comprising:
dividing a frequency band into a plurality of sub-bands for communicating between the radio stations in the ad-hoc mode, wherein the first radio station is assigned one or more first sub-bands and the second radio station is assigned one or more second sub-bands; and
sending a notification from the first radio station relating to the intended data transmission to the second radio station, the notification being sent only on one or more sub-bands selected from the group consisting of the one or more first sub-bands and the one or more second sub-bands;
receiving a notification at the second radio station from the first radio station relating to the intended data transmission from the first radio station to the second radio station; and
after receiving the notification, sending an acknowledgement from the second radio station to the first radio station to acknowledge the intended data transmission, the acknowledgement being sent only on one or more sub-bands selected from the group consisting of one or more first sub-bands and one or more second sub-bands.

30. The method as claimed in claim 29, wherein
the data transmission is performed on one or more sub-bands selected from the group consisting of:
the sub-band or sub-bands used to send the notification, and
the sub-band or sub-bands used to send the acknowledgment.

31. The method as claimed in claim 20, wherein
the second radio station receives the notification from the first radio station,
after receiving the notification, the second radio station sends an acknowledgement to the first radio station to acknowledge the intended data transmission, the acknowledgement being sent only on one or more sub-bands selected from the group consisting of one or more first sub-bands and one or more second sub-bands.

32. The method as claimed in claim 31, wherein
prior to sending the acknowledgement, the second radio station detects a current occupancy of the first and/or second sub-bands, and
the acknowledgement is sent only on one or more unoccupied sub-bands.

33. A radio station for communicating with another radio station in an ad-hoc mode of a radio communication system, comprising:
a first memory to store information identifying one or more first sub-bands assigned to the radio station for communicating, said sub-bands belonging to a frequency band which is divided into a plurality of sub-bands;
a second memory to store information identifying one or more second sub-bands assigned to the other radio station for communicating, said second sub-bands belonging to the frequency band; and
a transmitter to send the other radio station a notification of an intended data transmission to the other radio station, the transmitter sending the notification on one or more sub-bands selected from the group consisting of the one or more first sub-bands and the one or more second sub-bands.

34. The radio station as claimed in claim 33, wherein
before sending the notification, the transmitter detects a current occupancy of the first and/or second sub-bands, and
the transmitter sends the notification only on one or more unoccupied sub-bands.

35. A radio station for communicating with another radio station in an ad-hoc mode of a radio communication system, comprising:
a first memory to store information identifying one or more first sub-bands assigned to the radio station for communicating, said sub-bands belonging to a frequency band which is divided into a plurality of sub-bands;
a second memory to store information identifying one or more second sub-bands assigned to the other radio station for communicating, said second sub-bands belonging to the frequency band;
means for receiving and analyzing a notification from the other radio station, the notification indicating an intended data transmission to the radio station from the other radio station, the notification being received on one or more sub-bands; and
a transmitter to send an acknowledgement to the other radio station to acknowledge the intended data transmission, the acknowledgement being sent on one or more sub-bands selected from the group consisting of one or more first sub-bands and one or more second sub-bands.

36. The radio station as claimed in claim 35, wherein
before sending the acknowledgment, the transmitter detects a current occupancy of the first and/or second sub-bands, and
the transmitter sends the acknowledgment only on the one or more sub-bands used for the notification which are currently unoccupied.

37. A computer readable storage medium containing a computer program to control a computer to perform a process for a first radio station in an ad-hoc mode of a radio communication system, the process comprising:
selecting one or more sub-bands which will be used for sending, to a second radio station, a notification of an intended data transmission from the first radio station to the second radio station, said selection being made from one or more first sub-bands which have been assigned to the first radio station for communicating and/or from one or more second sub-bands which have been assigned to the second radio station for communicating, said sub-bands belonging to a frequency band which is divided into a plurality of sub-bands.

38. A computer readable storage medium containing a computer program to control a computer to perform a process for a second radio station in an ad-hoc mode of a radio communication system, the process comprising:
selecting one or more sub-bands which will be used for sending, to a first radio station, an acknowledgement of an intended data transmission from the first radio station to the second radio station, the acknowledgment being sent from the second radio station to the first radio station, said selection being made from one or more first sub-bands which have been assigned to the first radio station for communicating and/or from one or more second sub-bands which have been assigned to the second radio station for communicating, said sub-bands belonging to a frequency band which is divided into a plurality of sub-bands.
